(19) United States
(12) Patent Application Publication
(10) Pub. No.: US 2006/0187602 A1
(43) Pub. Date: Aug. 24, 2006

(54) Protection circuit and protection method

(76) Inventors: Osamu Kawagoe, Atsugi-Shi (JP); Akira Ikeuchi, Atsugi-Shi (JP); Hidenori Tanaka, Atsugi-Shi (JP)

Correspondence Address: LADAS & PARRY LLP, 224 SOUTH MICHIGAN AVENUE, SUITE 1600, CHICAGO, IL, 60604, US

(21) Appl. No.: 11/299,478

(22) Filed: Dec. 12, 2005

(30) Foreign Application Priority Data
Feb. 24, 2005 (JP) 2005-049479

(51) Int. Cl. H02H 3/20

(52) U.S. Cl. 361/91.1

(57) ABSTRACT

A protection circuit is disclosed that issues an instruction to blow a fuse connected to a power source in response to detection of an abnormality of a voltage of the power source. The protection circuit includes a time control unit that detects the voltage of the power source and controls the length of time from the detection of the abnormality of the voltage of the power source to the issue of the instruction to blow the fuse in accordance with the detected voltage.

### BACKGROUND OF THE INVENTION

1. Field of the Invention

The present invention generally relates to a protection circuit and a protection method, and particularly relates to a protection circuit and a protection method that issue an instruction to blow a fuse connected to a battery in response to detection of an abnormality of a voltage of the battery.

2. Description of the Related Art

There have been protection circuits that disconnect circuits from batteries by blowing fuses upon detection of an abnormality so as to protect the circuits. Examples of such protection circuits include an overcharge protection circuit adapted to prevent a battery from overcharging.

FIG. 5 shows a block diagram of an example of a battery protection system 100.

The battery protection system 100 comprises batteries 111-1 through 111-4, a protection IC 112, a fuse device 113, a charger 114, first through fourth resistances R, first through fourth capacitors C, a delay capacitor Ct, and a transistor M.

The batteries 111-1 through 111-4 are connected in series, with a positive terminal of the battery 111-1 connected to a terminal T+via the fuse device 113, and a negative terminal of the battery 111-4 connected to a terminal T−.

A connection point between the battery 111-1 and the fuse device 113 is connected to the protection IC 112 via the first resistance R. The first, second, and third capacitors C are connected between a detection terminal Ts1 and a detection terminal Ts2, the detection terminal Ts2 and a detection terminal Ts3, and the detection terminal Ts3 and a detection terminal Ts4 of the protection IC 112, respectively. The battery 111-1 is connected between the detection terminals Ts1 and Ts2 via an integration circuit including the first and second resistances R and the first capacitor C. The battery 111-2 is connected between the detection terminals Ts2 and Ts3 via an integration circuit including the second and third resistances R and the second capacitor C. The battery 111-3 is connected between the detection terminals Ts3 and Ts4 via an integration circuit including the third and fourth resistances R and the third capacitor C. The battery 111-4 is connected between the detection terminals Ts4 and Ts5 via an integration circuit including the fourth resistance R and the fourth capacitor C.

A terminal Tct of the protection IC 112 is connected to the delay capacitor Ct, while an output terminal Tout of the protection IC 112 is connected to a gate of the transistor M. The protection IC 112 detects overcharge of the individual batteries 111-1 through 111-4 by detecting voltages at each terminal of the batteries 111-1 through 111-4. In the event of detection of overcharge of any of the batteries 111-1 through 111-4, the protection IC 112 inverts the output of the output terminal Tout with a delay of a specified delay time determined by the delay capacitor Tct. The transistor M turns on in response to the inversion of the output of the output terminal Tout.

The transistor M includes a source and a back gate connected to the terminal T−, and a drain connected to the fuse device 113. The fuse device 113 comprises fuses F1 and F2, and heaters H1 and H2. The fuses F1 and F2 are connected in series between the terminal T+ and the batteries 111-1 through 111-4. The heaters H1 and H2 are connected parallel to each other to form a parallel circuit, which is connected in series between the drain of the transistor M and a connection point between the fuses F1 and F2. The heater H1 is arranged to face the fuse F1, while the heater H2 is arranged to face the fuse F2.

The charger 114, for example, is connected between the terminal T+ and the terminal T−. The charger 114 serves to charge the batteries 111-1 through 111-4. If the protection IC 112 is overcharged, a current is applied to the fuse device 113 to blow the fuses F1 and F2 arranged inside the fuse device 113. In this way, the batteries 111-1 through 111-4 are disconnected from the charger 114 for protection.

In this type of protection circuit, a supply voltage to a heater varies depending on the number of batteries connected. Accordingly, a heating value of the heater varies, resulting in a variation of time taken to blow a fuse.

### SUMMARY OF THE INVENTION

According to one aspect of the present invention, there is provided a protection circuit that makes constant the length of time from detection of an abnormality to blowing of a fuse.

According to another aspect of the present invention, there is provided a protection circuit that issues an instruction to blow a fuse connected to a power source in response to a detection of an abnormality of a voltage of the power source, the circuit including a time control unit that detects the voltage of the power source, and controls the length of time from the detection of the abnormality of the voltage of the power source to the issue of the instruction to blow the fuse in accordance with the detected voltage.

In the aforesaid protection circuit, the time control unit preferably includes a voltage detection unit that detects the voltage of the power source, and a delay unit that controls the length of time from the detection of the abnormality of the voltage of the power source to the issue of the instruction to blow the fuse in accordance with the voltage of the power source detected by the voltage detection unit.

The aforesaid delay unit preferably controls the length of time from the detection of the abnormality of the voltage of the power source to the issue of the instruction to blow the fuse in accordance with the detected voltage such that the length of time from the detection of the abnormality of the voltage of the power source to the blowing of the fuse is constant regardless of the detected voltage.

In the aforesaid protection circuit, the power source may include a battery.

According to still another aspect of the present invention, there is provided a protection method that protects a power source by blowing a fuse connected to the power source in response to a detection of an abnormality of a voltage of the power source, the method comprising a step of detecting the voltage of the power source, and a step of controlling the length of time from the detection of the abnormality of the voltage of the power source to the blowing of the fuse in accordance with the detected voltage so as to be constant regardless of the detected voltage.

According to the above-described aspects of the present invention, since the length of time from detecting the abnormality of the voltage of the power source to issuing the instruction to blow the fuse is controlled in accordance with the detected voltage of the power source, the length of time from detecting the abnormality to blowing the fuse is constant regardless of the detected voltage. Therefore, the quality of products using the above-described protection circuit or the protection method can be improved.

### BRIEF DESCRIPTION OF THE DRAWINGS

FIG. 1 is a schematic diagram showing a configuration of a battery protection system according to an embodiment of the present invention;

FIG. 2 is a block diagram of a protection IC;

FIG. 3 is a waveform diagram of a protection IC;

FIG. 4 is a waveform diagram of a protection IC; and

FIG. 5 is a schematic diagram showing a configuration of an example of a related-art battery protection system;

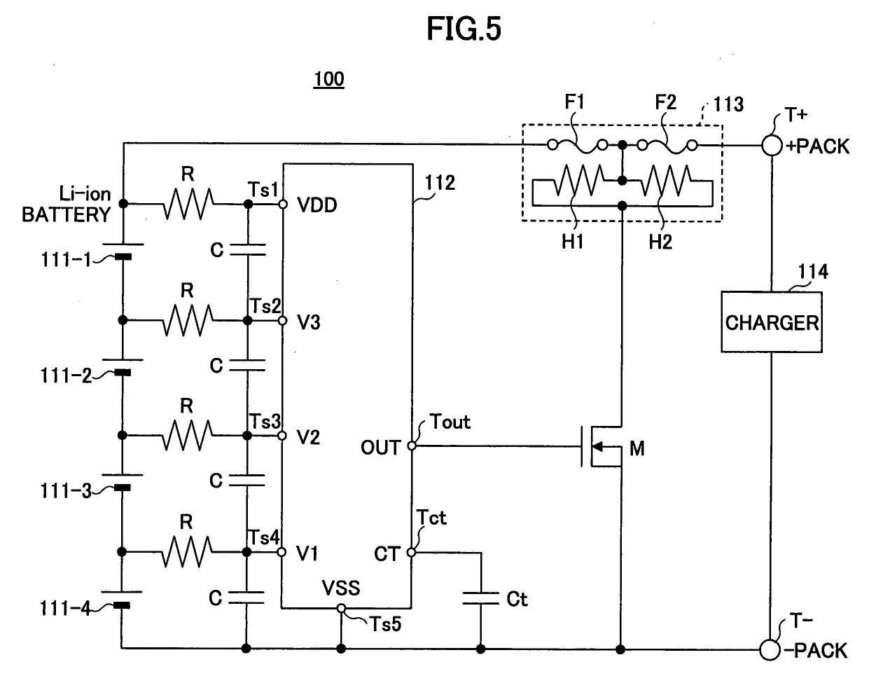

### DETAILED DESCRIPTION OF THE PREFERRED EMBODIMENT

[System Configuration]

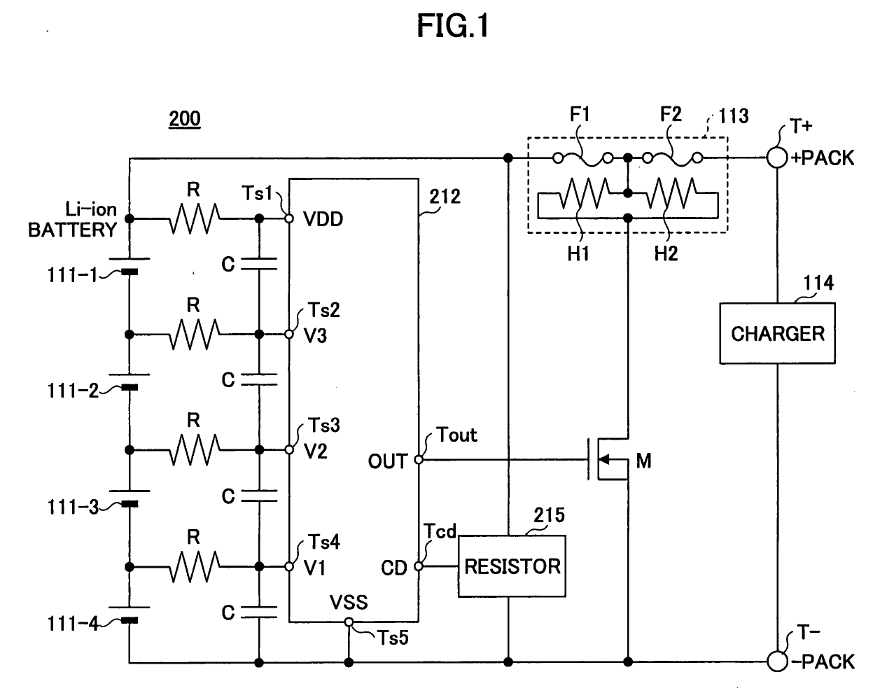

FIG. 1 is a schematic diagram showing a configuration of a battery protection system 200 according to an embodiment of the present invention.

The battery protection system 200 of this embodiment includes a protection IC 212, which is different from the protection IC 112 of the battery protection system 100. The protection IC 212 of this embodiment detects a series voltage of batteries 111-1 through 111-4, and controls the length of time from detecting overcharge to instructing a fuse device 113 to blow fuses F1 and F2 in accordance with the detected series voltage such that the length of time from detecting the overcharge to blowing the fuses F1 and F2 is constant regardless of the detected series voltage.

[Protection IC 212]

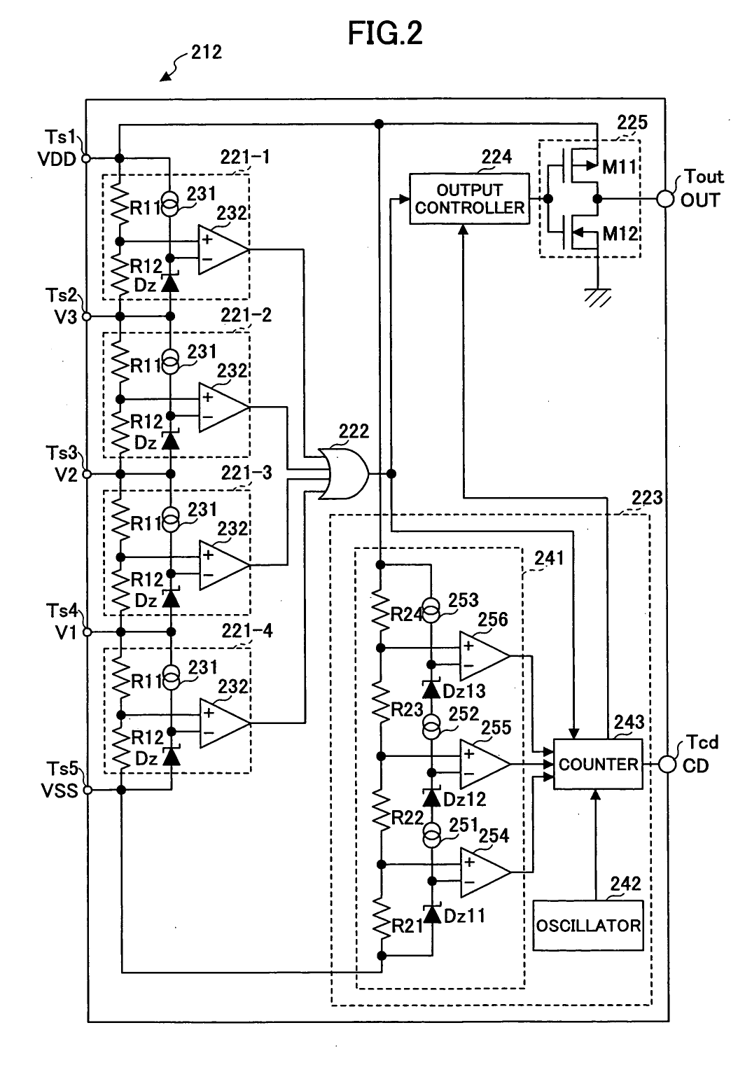

FIG. 2 is a block diagram of the protection IC 212.

The protection IC 212 of this embodiment serves as a protection circuit to prevent the four batteries 111-1 through 111-4 from overcharging. The protection IC 212 comprises overcharge detectors 221-1 through 221-4, an OR gate 222, a delay circuit 223, an output controller 224, and an inverter 225.

The overcharge detector 221-1 is connected between a terminal Ts1 and a terminal Ts2 and configured to detect overcharge of the battery 111-1 by detecting a voltage between the terminal Ts1 and the terminal Ts2. The overcharge detector 221-1 comprises resistances R11 and R12, a current source 231, a zener diode Dz, and a comparator 232. The resistances R11 and R12 are connected in series between the terminal Ts1 and the terminal Ts2 so as to divide the voltage between the terminal Ts1 and the terminal Ts2 and output the divided voltage from a connection point between the resistance R11 and the resistance R12. The connection point between the resistance R11 and the resistance R12 is connected to a non-inverting input terminal of the comparator 232. The current source 231 and the zener diode Dz are connected in series between the terminal Ts1 and the terminal Ts2 so as to generate a reference voltage from the voltage between the terminal Ts1 and the terminal Ts2. The reference voltage is output from a connection point between the current source 231 and the zener diode Dz. The reference voltage output from the connection point between the current source 231 and the zener diode Dz is supplied to an inverting input terminal of the comparator 232. The comparator 232 compares the detected voltage at the connection point between the resistance R11 and the resistance R12 with the reference voltage at the connection point between the current source 231 and the zener diode Dz. If the detected voltage is lower than the reference voltage, the output of the comparator 232 is set to low level. If otherwise the detected voltage is higher than the reference voltage, the output of the comparator 232 is set to high level. The output of the comparator 232 is supplied to the OR gate 222.

The overcharge detector 221-2 is connected between the terminal Ts2 and a terminal Ts3 and configured to detect overcharge of the battery 111-2 by detecting a voltage between the terminal Ts2 and the terminal Ts3. The overcharge detector 221-2 has the same construction as the overcharge detector 221-1. The output of the overcharge detector 221-2 is supplied to the OR gate 222.

The overcharge detector 221-3 is connected between the terminal Ts3 and a terminal Ts4 and configured to detect overcharge of the battery 111-3 by detecting a voltage between the terminal Ts3 and the terminal Ts4. The overcharge detector 221-3 has the same construction as the overcharge detector 221-1. The output of the overcharge detector 221-3 is supplied to the OR gate 222. The overcharge detector 221-4 is connected between the terminal Ts4 and a terminal Ts5 and configured to detect overcharge of the battery 111-4 by detecting a voltage between the terminal Ts4 and the terminal Ts5. The overcharge detector 221-4 has the same construction as the overcharge detector 221-1. The output of the overcharge detector 221-4 is supplied to the OR gate 222.

The OR gate 222 outputs a logical OR of the outputs of the overcharge detectors 221-1 through 221-4. The output of the OR gate 222 is supplied to the delay circuit 223 and the output controller 224.

[Delay Circuit 223]

The delay circuit 223 is configured to detect the series voltage of the four batteries 111-1 through 111-4 so as to control a delay time in accordance with the detected series voltage. The delay circuit 223 comprises a battery voltage detector 241, an oscillator 242, and a counter 243.

[Battery Voltage Detector 241]

The battery voltage detector 241 comprises resistances R21 through R24, current sources 251 through 253, zener diodes Dz11 through Dz13, comparators 254 through 256, and is configured to detect the series voltage of the four batteries 111-1 through 111-4.

The resistances R21 through R24 are connected in series between the terminal Ts1 and the terminal Ts5 so as to divide a voltage between the terminal Ts1 and the terminal Ts5, i.e., a sum of voltages produced by the four batteries 111-1 through 111-4. A voltage at a connection point between the resistance R21 and the resistance R22 is supplied to a non-inverting input terminal of the comparator 254. A voltage at a connection point between the resistance R22 and the resistance R23 is supplied to a non-inverting input terminal of the comparator 255. A voltage at a connection point between the resistance R23 and the resistance R24 is supplied to a non-inverting input terminal of the comparator 256.

The current sources 251 through 253 and the zener diodes Dz11 through Dz13 are alternately connected in series between the terminal Ts1 and the terminal Ts5. A first reference voltage Vref is generated at a connection point between the current source 251 and the zener diode Dz11. The first reference voltage Vref generated at the connection point between the current source 251 and the zener diode Dz11 is supplied to an inverting input terminal of the comparator 254.

A second reference voltage 2×Vref is generated at a connection point between the current source 252 and the zener diode Dz12. The second reference voltage 2×Vref generated at the connection point between the current source 252 and the zener diode Dz12 is supplied to an inverting input terminal of the comparator 255.

A third reference voltage 3×Vref is generated at a connection point between the current source 253 and the zener diode Dz13. The third reference voltage 3×Vref generated at the connection point between the current source 253 and the zener diode Dz13 is supplied to an inverting input terminal of the comparator 256.

If the series voltage of the four batteries 111-1 through 111-4 is high enough to make the voltage at the connection point between the resistance R23 and the resistance R24 higher than the third reference voltage, the outputs of all the comparators 254 through 256 are set to high level. On the other hand, if the series voltage of the four batteries 111-1 through 111-4 is reduced and therefore the voltage at the connection point between the resistance R23 and the resistance R24 falls below the third reference voltage, the output of the comparator 254 is set to low level although the outputs of the comparators 255 and 256 remain at the high level.

If the series voltage of the four batteries 111-1 through 111-4 is further reduced and therefore the voltage at the connection point between the resistance R22 and the resistance R23 falls below the second reference voltage, the outputs of the comparators 254 and 255 are set to low level although the output of the comparator 256 remains at the high level. If the series voltage of the four batteries 111-1 through 111-4 is further reduced and therefore the voltage at the connection point between the resistance R21 and the resistance R22 falls below the first reference voltage, the outputs of all the comparators 254 through 256 are set to low level.

As such, the series voltage of the four batteries 111-1 through 111-4 is detected based on the outputs of the comparators 254 through 256. The outputs of the comparators 254 through 256 are supplied to the counter 243.

[Counter 243]

The counter 243 counts down the count pulse, which may be, for example, the oscillation pulse of the oscillator 242 with a frequency divided based on signals from the comparators 254 through 256. The counter 243 starts a countdown from a count value preset by a delay terminal Tcd after the output of the OR gate 222 is set to high level.

The frequency of the count pulse is divided to have: long cycles when the outputs of all the comparators 254 through 256 are high level; medium cycles when the outputs of the comparators 254 and 255 are high level; and short cycles when the output of only the comparator 254 is high level. The counter 243 switches its output to high level when the count reaches 0. It is therefore possible to increase the delay time from the point when the output of the OR gate 222 is switched to high level in response to detection of overcharge of any of the batteries 111-1 through 111-4 to the point when the instruction to blow the fuses F1 and F2 is issued as the series voltage of the batteries 111-1 through 111-4 increases, and to reduce the delay time as the series voltage of the batteries 111-1 through 111-4 decreases.

The output of the counter 243 is supplied to the output controller 224. The output controller 224 inverts its output from high level to low level when the output of the counter 234 is switched to high level. The output of the output controller 224 is supplied to the inverter 225. The inverter 225 inverts the output of the output controller 224, and outputs the inverted output from an output terminal Tout.

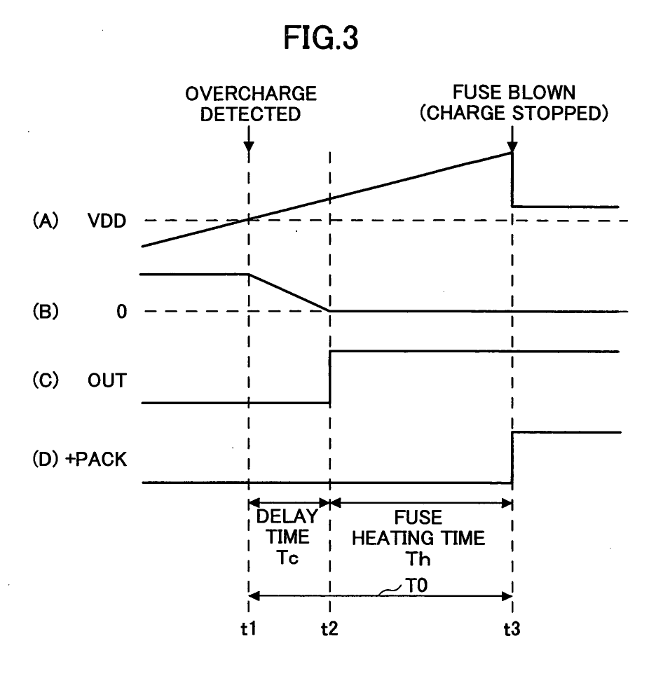

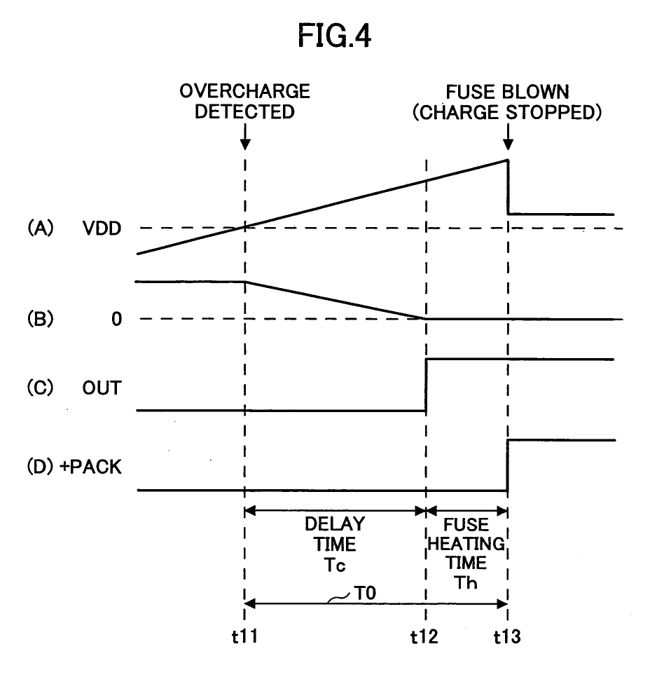

FIGS. 3 and 4 illustrate waveform diagrams of the protection IC 212. The diagram of FIG. 3 shows a waveform produced when the series voltage of the batteries 111-1 through 111-4 is low. On the other hand, the diagram of FIG. 4 shows a waveform produced when the series voltage of the batteries 111-1 through 111-4 is high. In the waveform diagrams of FIGS. 3 and 4, (A) indicates a voltage VDD between the terminal Ts1 and the terminal Ts5; (B) indicates the count value of the counter 243; (C) indicates an output voltage of the output terminal Tout; and (D) indicates a voltage of a terminal T+.

The following describes operations performed when the series voltage of the batteries 111-1 through 111-4 is low during charging of the batteries 111-1 through 111-4 with reference to FIG. 3. Upon detection of overcharge at time t1, the counter 243 starts a countdown of the count pulse. When the count reaches 0 at time t2, the output of the counter 243 is set to high level. In response, the output of the output controller 224 is set to low level, and the output of the output terminal Tout is set to high level. When the output of the output terminal Tout is set to high level, a transistor M is turned on. Thus, a current is applied to heaters H1 and H2 to start heating the fuses F1 and F2. When a heating temperature of the heaters H1 and H2 reaches a melting temperature of the fuses F1 and F2 at t3, the fuses F1 and F2 are blown.

In this case, since the series voltage of the batteries 111-1 through 111-4 is low, a voltage applied to the heaters H1 and H2 is low. The time that the heaters H1 and H2 take to reach the melting temperature is therefore relatively long. Accordingly, in the length of time T0 from detecting the overcharge to blowing the fuses F1 and F2, a delay time Tc is short while a heating time Th is long.

The following are operations performed when the series voltage of the batteries 111-1 through 111-4 is high with reference to FIG. 4. Upon detection of overcharge at time t11, the counter 243 starts a countdown of the count pulse. When the count reaches 0 at time t12, the output of the counter 243 is set to high level. In response, the output of the output controller 224 is set to low level, and the output of the output terminal Tout is set to high level. When the output of the output terminal Tout is set to high level, the transistor M is turned on. Thus, a current is applied to the heaters H1 and H2 to start heating the fuses F1 and F2. When the heating temperature of the heaters H1 and H2 reaches the melting temperature of the fuses F1 and F2 at tl3, the fuses F1 and F2 are blown.

In this case, since the series voltage of the batteries 111-1 through 111-4 is high, the voltage applied to the heaters H1 and H2 is high. The time that the heaters H1 and H2 take to reach the melting temperature is therefore relatively short. Accordingly, in the length of time T0 from detecting the overcharge to blowing the fuses F1 and F2, the delay time Tc is long while the heating time Th is short.

According to the embodiment described above, the delay time Tc can be controlled such that the length of time T0 from detecting the overcharge to blowing the fuses F1 and F2 is constant. Therefore, the quality of products using the protection circuit 212 can be improved.

The present application is based on Japanese Priority Application No. 2005-049479 filed on Feb. 24, 2005, with the Japanese Patent Office, the entire contents of which are hereby incorporated by reference.

What is claimed is:

1. A protection circuit that issues an instruction to blow a fuse connected to a power source in response to a detection of an abnormality of a voltage of the power source, comprising:
a time control unit that detects the voltage of the power source, and controls the length of time from the detection of the abnormality of the voltage of the power source to the issue of the instruction to blow the fuse in accordance with the detected voltage.

2. The protection circuit as claimed in claim 1, wherein the time control unit includes:
a voltage detection unit that detects the voltage of the power source; and
a delay unit that controls the length of time from the detection of the abnormality of the voltage of the power source to the issue of the instruction to blow the fuse in accordance with the voltage of the power source detected by the voltage detection unit.

3. The protection circuit as claimed in claim 2, wherein the delay unit controls the length of time from the detection of the abnormality of the voltage of the power source to the issue of the instruction to blow the fuse in accordance with the detected voltage such that the length of time from the detection of the abnormality of the voltage of the power source to the blowing of the fuse is constant regardless of the detected voltage.

4. The protection circuit as claimed in claim 1, wherein the power source includes:
a battery.

5. A protection method that protects a power source by blowing a fuse connected to the power source in response to a detection of an abnormality of a voltage of the power source, comprising the steps of:
detecting the voltage of the power source; and
controlling the length of time from the detection of the abnormality of the voltage of the power source to the blowing of the fuse in accordance with the detected voltage so as to be constant regardless of the detected voltage.
